(19) United States
(12) Patent Application Publication
(10) Pub. No.: US 2015/0161664 A1
(43) Pub. Date: Jun. 11, 2015

(54) METHOD AND SYSTEM FOR COLLECTING DATA ON BUSINESSES VIA MOBILE AND GEOLOCATION COMMUNICATIONS

(71) Applicant: THE DUN & BRADSTREET CORPORATION, Short Hills, NJ (US)

(72) Inventor: Michael S. KOPPELMANN, Denville, NJ (US)

(21) Appl. No.: 14/559,982

(22) Filed: Dec. 4, 2014

Related U.S. Application Data
(60) Provisional application No. 61/912,827, filed on Dec. 6, 2013.

(51) Int. Cl. G06Q 30/02; G06F 3/0484; G06F 3/0482; G06F 3/0481

(52) U.S. Cl. CPC G06Q 30/0259; G06F 3/04817; G06F 3/04842; G06F 3/0482

(57) ABSTRACT

A method for reporting data concerning a business, comprising: providing, on a device, a map of the geographic location of the business, wherein the business is represented by a marker on the map; selecting the marker to display the name of the business; receiving an instruction to open a toolbar to provide options for inputting information concerning the business; providing information concerning the business to the device via at least one of the options; and transmitting the information to a central database by using the device.

### CROSS-REFERENCED APPLICATION

This application claims priority on U.S. Provisional Application, Ser. No. 61/912,827, filed on Dec. 6, 2013, which is incorporated herein in its entirety by reference thereto.

### BACKGROUND

1. Field of the Disclosure

The present disclosure relates to a method and to a system for obtaining information concerning businesses.

2. Description of the Related Art

Businesses always need information on other businesses. Businesses may need information on whether to conduct transactions with another business, especially information relating to whether another business is really a going concern and is capable of paying for goods and services received.

There are many well established techniques for acquiring information concerning the state of a business. Individual businesses can be separately researched, especially if the stock of a company is publically traded and the company is subject to regulatory reporting requirements.

Dun & Bradstreet, Inc. is considered by many to be the world's leading supplier of information on businesses. While Dun & Bradstreet, Inc. uses many powerful techniques to assure that the information it supplies is accurate, there is a constant search for better and more efficient systems and methods to accumulate and verify the accuracy of information concerning the state of a business.

The difficulty with many conventional techniques for determining the state of a business and its ability to pay for goods and services are subject to error or deception.

Thus, there is a need for a system and method to facilitate the collection of data on businesses, and in particular small business, where there may be scant public information and where what information is available may be inaccurate or may be subject to manipulation.

### SUMMARY

In general, an embodiment of the disclosure is directed to a system and a method for providing an incentive for the submission of information concerning a business, especially when individuals are temporarily in the vicinity of a business. The incentive may be provided by assigning points for a submission, and by instituting a competitive game providing company recognition or incentives relating to the number of points accumulated as a result of submitting information.

The disclosure is directed to a method and to a system for reporting data concerning a business. The method comprises providing, on a device, a map of the geographic location of the business, wherein the business is represented by a marker on the map; selecting the marker to display the name of the business; receiving an instruction to open a toolbar to provide options for inputting information concerning the business; providing information concerning the business to the device via at least one of the options; and transmitting the information to a central database by using the device.

The toolbar can include icons for inputting data as to whether the business is being run out of a residence, a camera for providing an image of the location of the business, a map of the location of the business, and a notebook for entering information concerning the business. Selecting an icon on the toolbar causes the device to display screens for inputting the information concerning the business.

Selecting the icon for inputting data as to whether the business is being run out of a residence causes the device to display a screen with a yes button, a no button and a submit button. Selecting the icon of a camera causes the device to display an image generated by a camera of the device, and a button for selecting the image for reporting. The image is acquired by using the camera to capture an image of the business.

Selecting the map icon causes the device to display a screen for entering information for each of whether the business is at a location, whether it appears that business is being conducted at that location, whether the location is vacant, whether a different business is present at the location, and whether the different business appears to be doing business at the location.

Selecting the notebook icon causes the device to display screens for entering information for each of the telephone number of the business, who is in charge of the business, the title of who is in charge of the business, and a uniform resource locator of a website of the business.

The current position of the device may be determined by using a GPS receiver associated with the device.

The reporting of data concerning a business earns points of a game for users of the device. The system and method can allow a user of the device to chatter with other users of other devices who are acquiring information concerning businesses.

Another embodiment of the disclosure is directed to a computer readable non-transitory storage medium storing instructions of a computer program which when executed by a computer system results in performance of steps of a method for reporting data concerning a business, comprising providing, on a device having the computer system, wherein the computer system has a processor, a memory and a display, a map of the geographic location of the business on the display, wherein the business is represented by a marker on the map; displaying the name of the business if the marker is selected; receiving an instruction to open a toolbar to provide options for inputting information concerning the business; providing information concerning the business to the device via at least one of the options; and transmitting the information to a central database by using the device.

### BRIEF DESCRIPTION OF THE DRAWINGS

FIG. 1 is a flow chart of a portion of the operation of the system.

FIGS. 2A, 2B and 2C show screens of a mobile device on which the system and method are implemented.

FIGS. 3A to 3H illustrate the use of a camera to acquire a photograph of a business, and to connect to chatter.

FIG. 4A to FIG. 4E show screens of a mobile device as a map function is used.

FIG. 5 is a flow chart showing the steps in using an action icon toolbar, a house icon and a camera icon.

FIG. 6A to 6D show screens of a mobile device used to report when a business is based in a home.

FIG. 7A to 7E show screens of a mobile device used when a business is based at a usual business location other than a home.

FIG. 8A is a flow chart of the manner in which a user unlocks a map and signs up for chatter communication.

FIG. 8B is a flow chart of the use of a map icon.

FIGS. 9A to 9H show screens of a mobile device when following the steps of the flow chart of FIG. 8A.

FIGS. 10A to 10H show screens of a mobile device when using the map icon.

FIG. 11A is a flow chart of the manner in which a user unlocks a notebook.

FIG. 11B is a flow chart of the use of a notebook icon.

FIG. 12A to FIG. 12D show screens of a mobile device when following the flow chart of FIG. 11B.

FIG. 13 is a flow chart of side navigation on a mobile device.

FIG. 14 is a block diagram of a computer system in a mobile device as described above.

A component or a feature that is common to more than one drawing is indicated with the same reference number in each of the drawings.

### DESCRIPTION OF THE PREFERRED EMBODIMENTS

In general, to use the system and method described herein, an application or “App” is downloaded to a mobile device (such as a smart telephone or a tablet device) from an applications hub (not shown); that can be a server that downloads applications to the mobile device. A company having employees that use the mobile device in the manner described herein will verify that an employee has access based on data in an active directory 100 upon login at 102. A hub directory 104 can contain information to verify login information for individuals other than employees, who have been granted access.

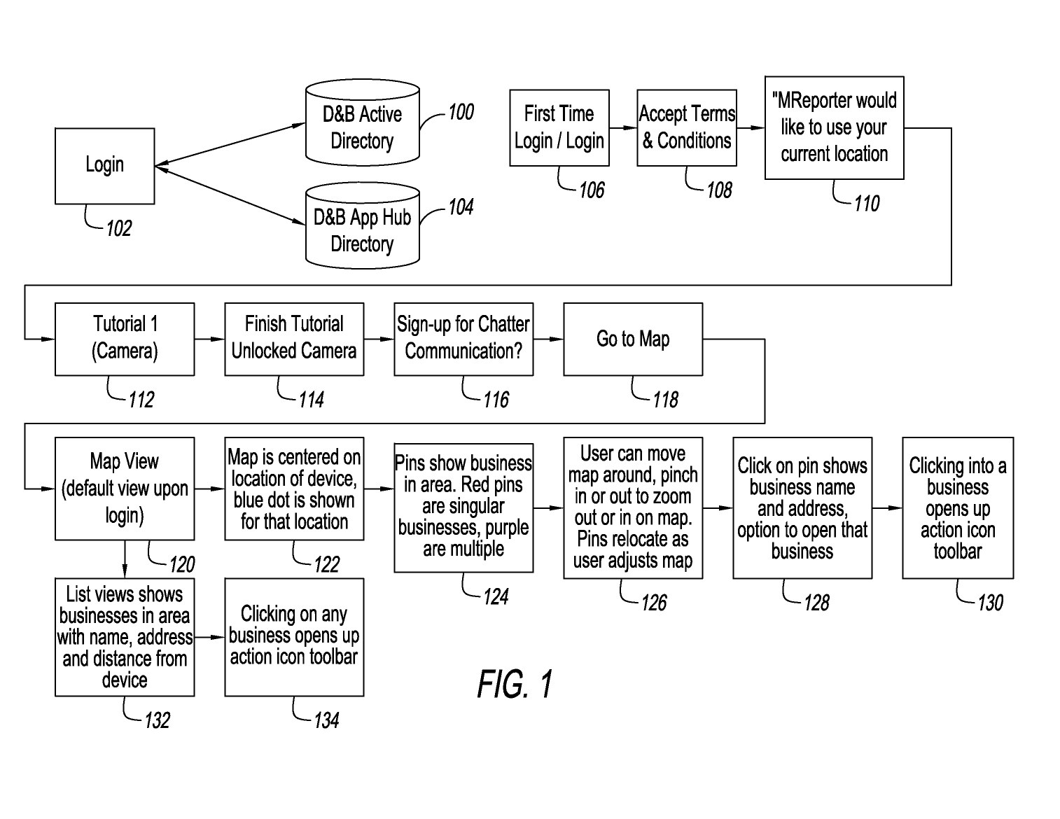

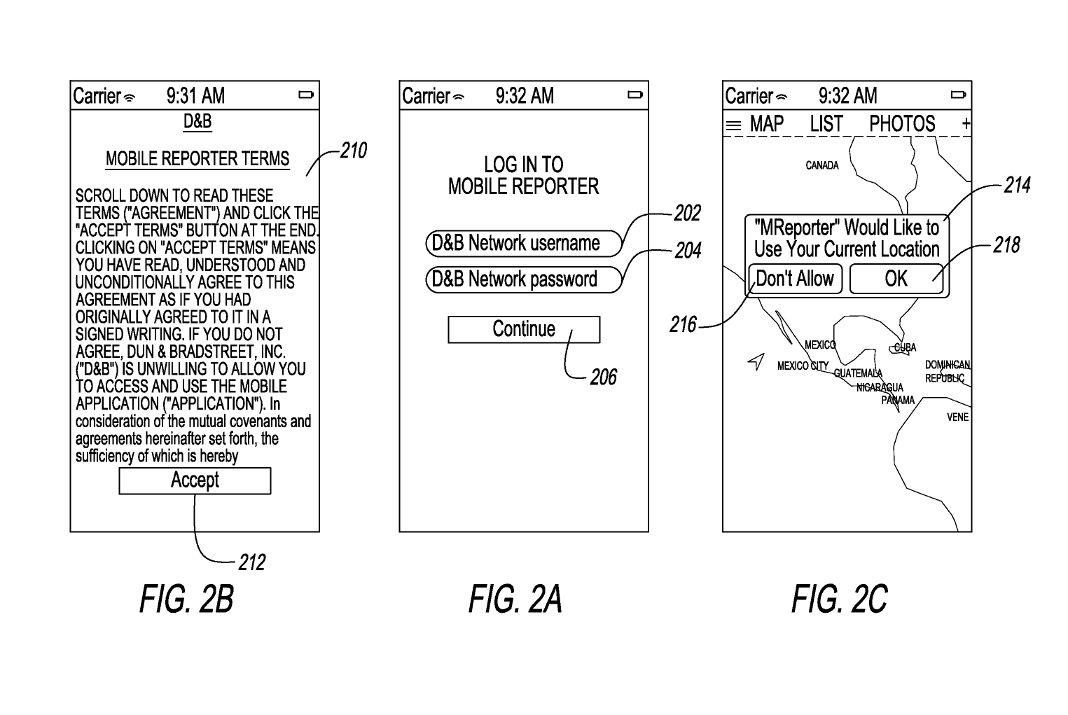

FIG. 1, after the “App” has been downloaded to the mobile device, in general, a user of the mobile device logs in at 106, using a log in screen such as that of FIG. 2A, where there are fields 202 and 204 for a user name and a password, respectively, and a continue button 206. During a first time log in only, at 106, a screen, at 108, and as illustrated in FIG. 2B displays the terms and conditions 210 for the use of the software of the App. The user will activate a button 212 to accept those terms and conditions if the user wishes to use the App.

It will be understood that the screen will generally be a touch screen, so that buttons or active regions may be activated by simply touching those buttons or regions with a finger or a stylus, or by moving a cursor to those buttons or areas, and simply “clicking” on them, as is well known in the art.

In FIG. 1, at 110, the user is told that the system would like to use the current location to acquire data. The current location can be determined by using a GPS receiver associated with the device. As an alternative, the location of the device can be entered into the device by a user interface (not shown) as a street address, an intersection of two streets, or known GPS coordinates.

In FIG. 2C, a screen portion 214 appears that gives the user the option of allowing or not allowing the use of current position, thus providing the user the ability to maintain some degree of privacy, if for some reason the user does not want his current location known. By using button 216, the user can decline to allow his current position to be used. By using button 218, the user can allow his current position and subsequent positions to be used in association with data that is obtained.

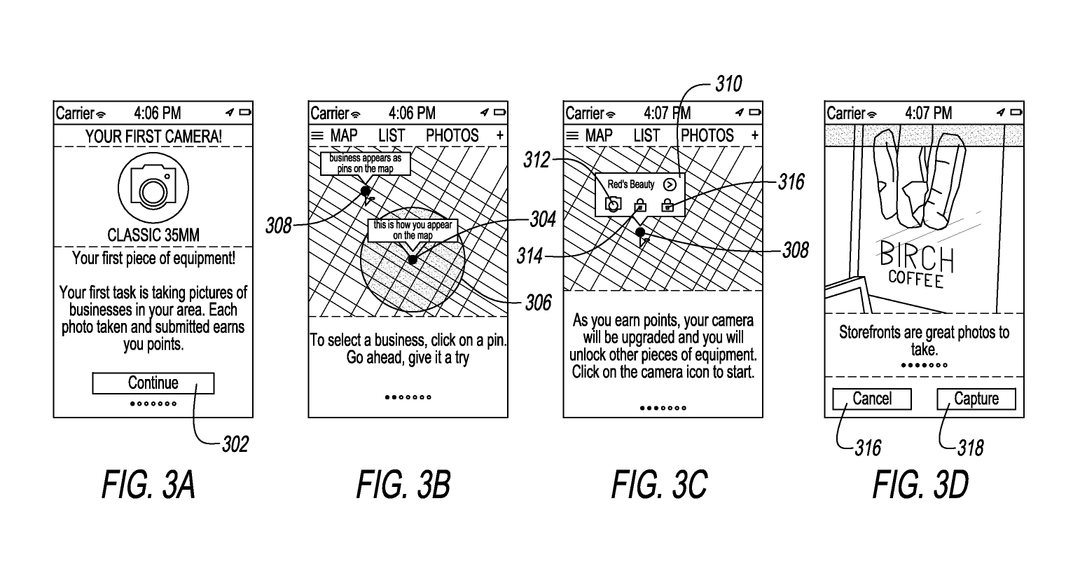

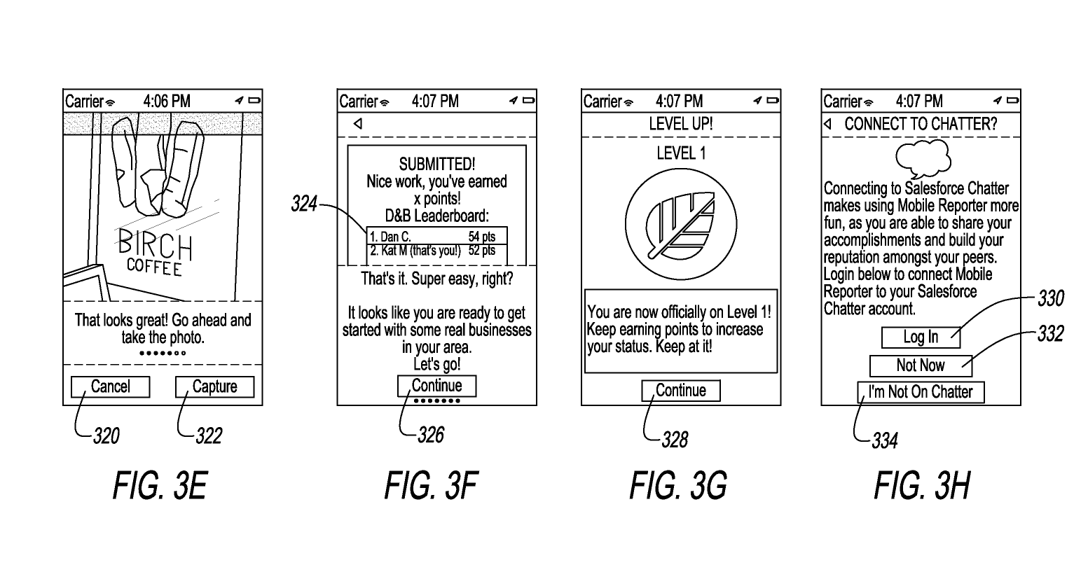

Continuing in FIG. 1, at the time of first log in, or later if desired, at 112 a first tutorial, concerning the use of a camera on the mobile device, is activated for display. A series of screens as represented by FIGS. 3A to 3H provide the tutorial. In FIG. 3A, the camera tutorial is started and indicates that the user's first task is taking pictures of businesses in his area and that each photo taken and submitted earns points. The user continues by hitting the continue button 302. In FIG. 3B, a local street map of an area appears. The location of the digital device that is being used appears as a small circle 304 surrounded by a larger circle 306. Businesses appear as pins 308 on the street map. The user is instructed that to select a business, the user must click on a pin and is encouraged to go ahead and to give it a try.

Referring to FIG. 3C when a business has been selected in FIG. 3B, by selecting a pin, a display region 310 appears showing a camera 312 and whether the camera is unlocked, as represented by icon 314, or locked, as represented by icon 316. The street map appears at an enlarged scale. The user is informed that as points are earned, the camera will be upgraded and other pieces of equipment will be unlocked. The user is advised the click on the camera icon to start.

In FIG. 3D, after selecting the camera icon in FIG. 3C, an image associated with a business, such as a storefront, is displayed. The user has the option of pushing a button 316 to cancel the acquisition of the displayed image or a button 318 to capture the displayed image. In FIG. 3E, the image has been properly focused and again the user is given the option of canceling the image with button 320, or capturing the image with button 322.

If the user captures the image by activating button 322 of FIG. 3E, then a screen appears as illustrated in FIG. 3F, which informs the user that the photograph has been submitted, and the number of points earned by that submission. At 324 a list of individuals and their total points earned may be displayed. The user is informed that she appears to be ready to get started with real businesses in her area. The user may do so by activating a button 326.

In FIG. 3G, the user is informed that she is on level 1 of the game and is encouraged to keep at it, by earning more points. The user continues by pressing a button 328.

Referring again to FIG. 1, at 114, this finishes the tutorial and unlocks the camera of the device being used. At 116, corresponding to FIG. 3H, the user is given the option of connecting to sales force chatter. Such connection makes using the mobile reporter application described herein more fun as the user is able to share her accomplishments and build a reputation amongst peers. To connect the mobile device to the sales force chatter account, the user can log in by activating a button at 330. However, the user may indicate that she does not want to connect to chatter at the present time with a button 332. If the user is not on chatter at all, this can be indicated by activating button 334.

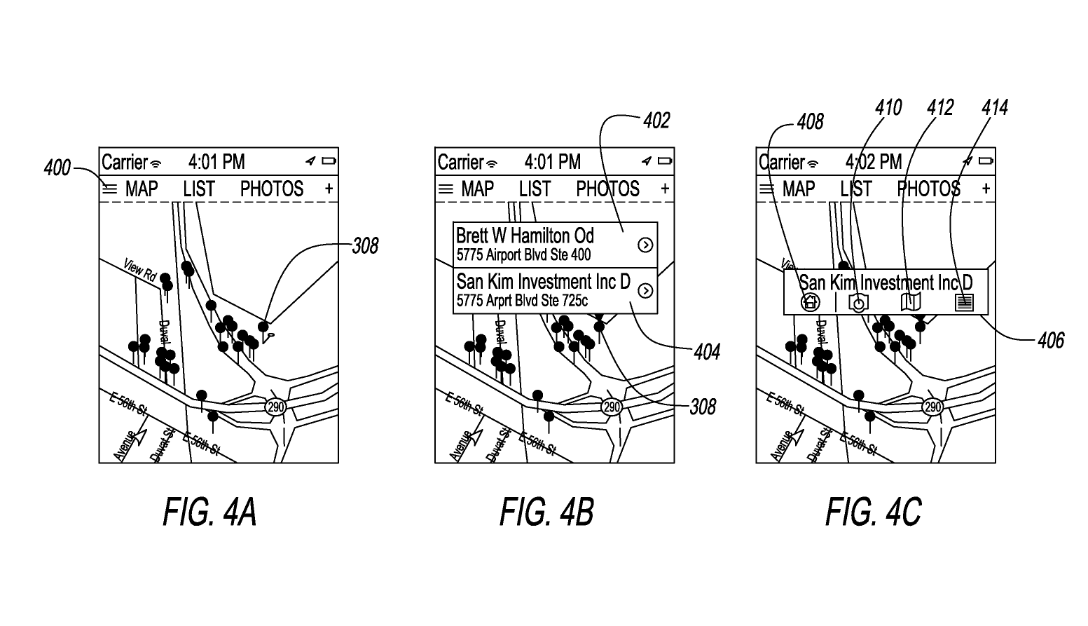

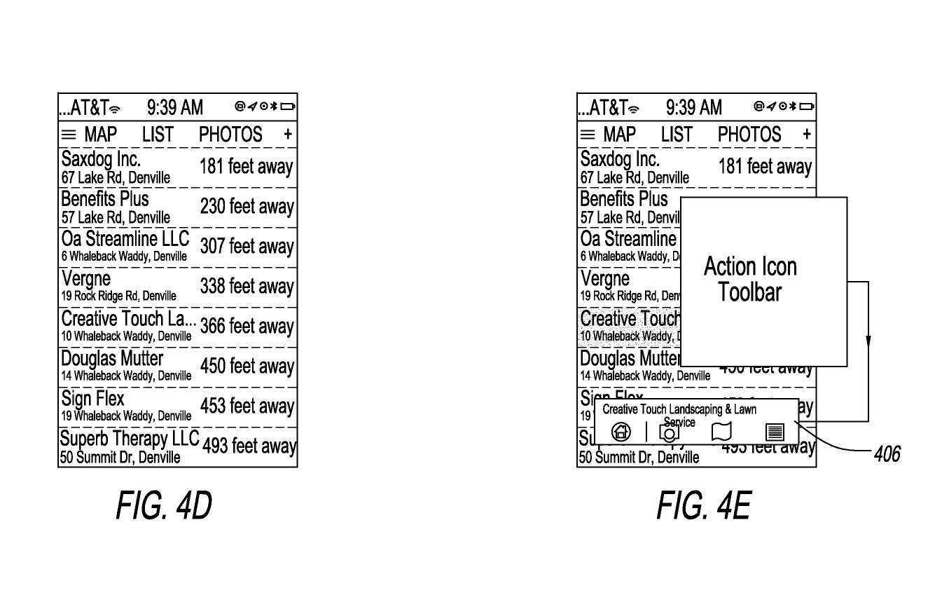

In FIG. 1, at 118, regardless of the decision at 116, flow continues to the map function. At 120, a map view mode, which may be the default view when a user logs on, is entered. At 122 a map is centered on the location of the user's device with a blue dot displayed for that location. At 124, as represented in FIG. 4A, FIG. 4B and FIG. 4C, different pins 308 of different colors are used to represent the businesses in the immediate area. For example, red pens may be used the singular businesses and purple pins may be used for multiple businesses at a given location. At 126, as represented in FIG. 4A, FIG. 4B and FIG. 4C, the user can displace the map in various directions and pinch in or out to zoom in or out on the map. Pins 308 automatically relocate as the user adjusts the map.

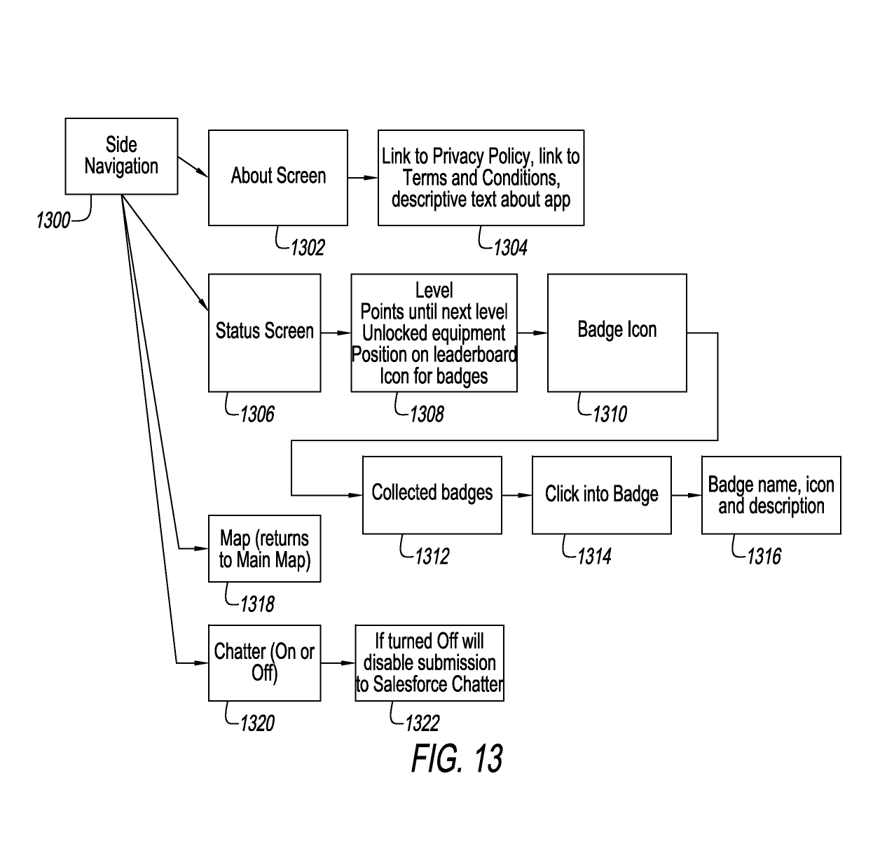

An icon 400 of FIG. 4A (or any display in the map mode) may be used for side navigation, as more fully described with respect to FIG. 13.

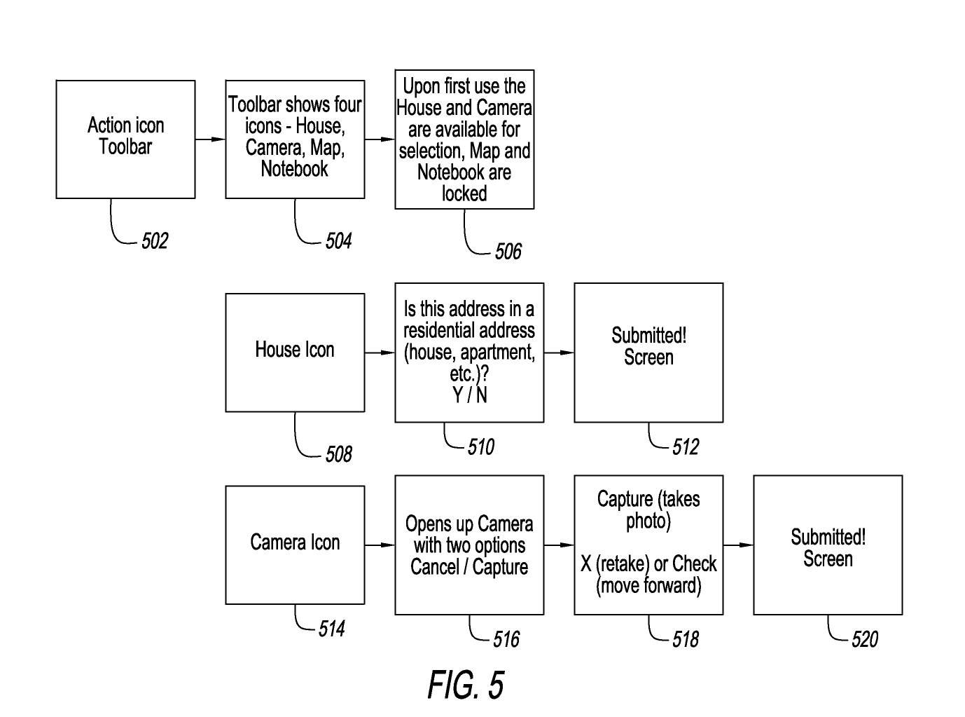

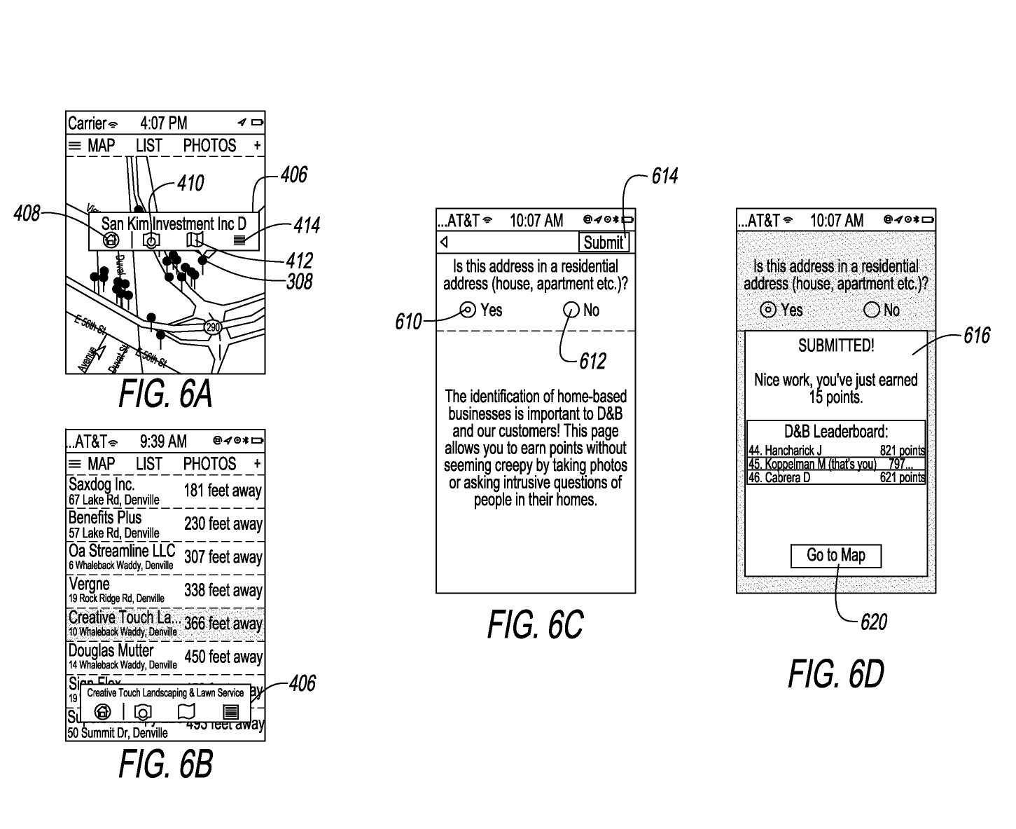

At 128, as represented in FIG. 4B, the user may click on a pin 308 to show display regions 402, 404 etc. to display the business name or names and address at that location. For each business at that location, or for a single business at that location, an indicator with the business name and address will then appear. Clicking on an indicator 402 or 404 opens an icon, in the form of an action icon toolbar 406, as shown in FIG. 4C, and as discussed with respect to FIG. 5 and FIG. 6A. Action icon toolbar 406 has four icons which include a house 408, a camera 410, a map 412, and a notebook 414.

At 132 of FIG. 1, the user may select a list view (by clicking on the word LIST in any display having that word), as illustrated in FIG. 4D, which displays a list of businesses in the area, each with its name address and distance from the user's device. At 134, clicking on any business on the list opens the action icon toolbar 406, as shown in FIG. 4E, and as further described with respect to FIG. 5.

In FIG. 5, at 502, the action icon toolbar 406 is accessed, as represented in FIG. 6A. At 504, the action icon toolbar 406, as shown in FIG. 6A, is opened. When clicking on a pin 308, in FIG. 6B, a list of businesses at the location of the selected pin 308 is displayed.

At 506, upon the device being used for the first time, the house icon 408 and the camera icon 410 are available for selection. However, the map icon 412 and the notebook icon 414 are locked.

At 508, the house icon may be activated. At 510 the user is presented with a screen as represented in FIG. 6C, where the user is queried as to whether the address is a residential address, such as that of a house or apartment.

Button 610 is activated if the answer is YES. Button 612 is activated if the answer is NO. After the yes or no selection has been made, the information is submitted by clicking on 614. At 512 of FIG. 5, a submitted screen is displayed to the user. This is shown in FIG. 6D, where once the information has been submitted an indicator 616 notes the submission and displays the leaders who have the highest points, as in 324 of FIG. 3A. The user returns to the map display by activating button 620.

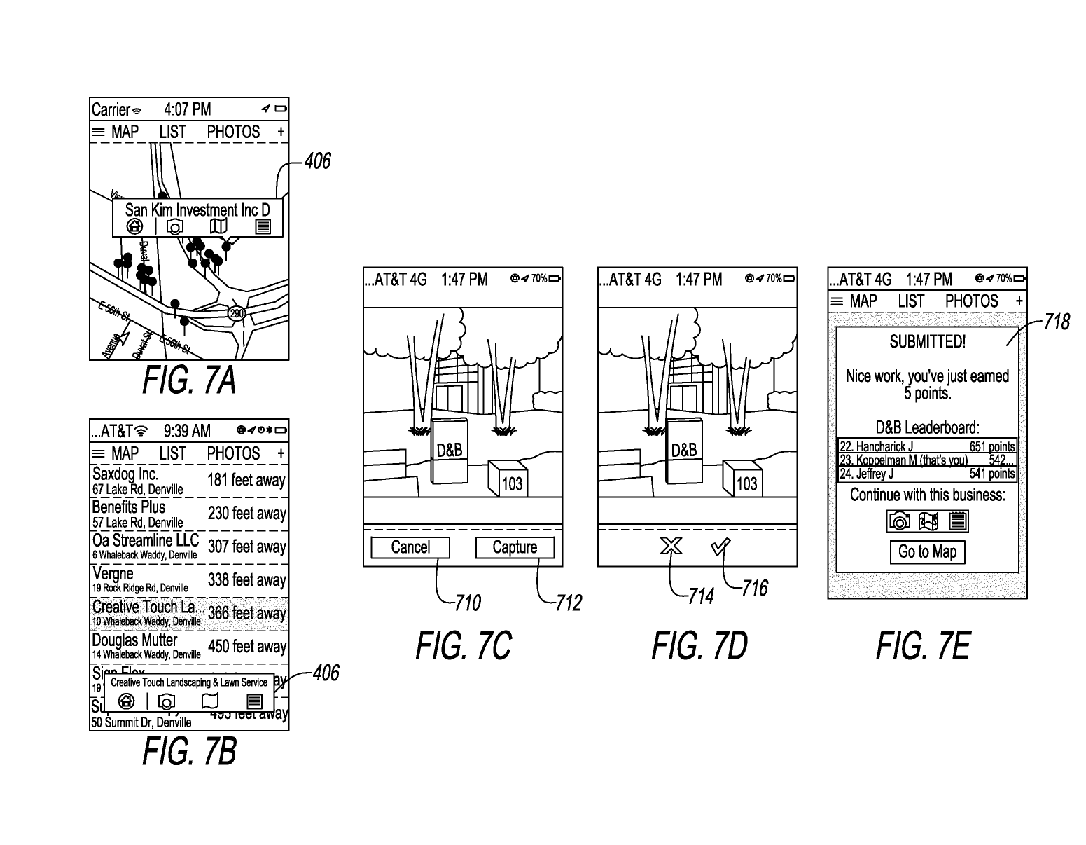

In FIG. 5, if the camera icon is selected at 514, as shown in FIG. 7A and FIG. 7B, there are two options, at 516 for the camera. As shown in FIG. 7C, these are using one of cancel button 710 and capture button 712. If capture button 712 is selected, then there are two options at 518 as represented in FIG. 7D. If the X mark 714 is selected, the photograph will be discarded. If the check mark 716 is selected, the photograph is submitted and at 520, the submitted screen 718 is displayed, as shown in FIG. 7E.

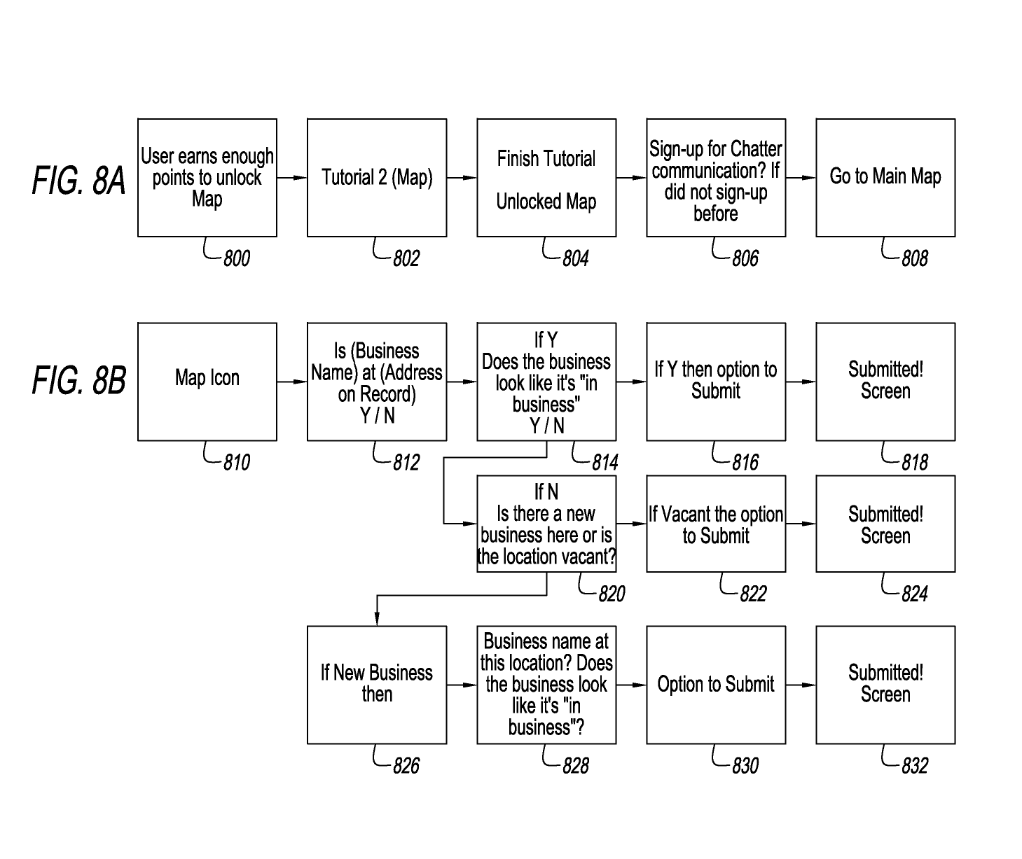

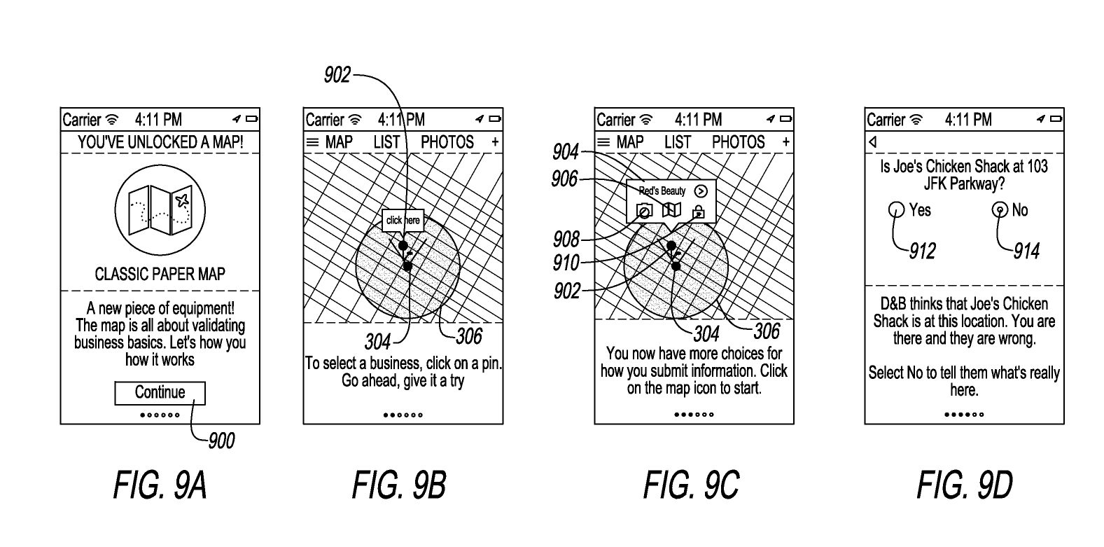

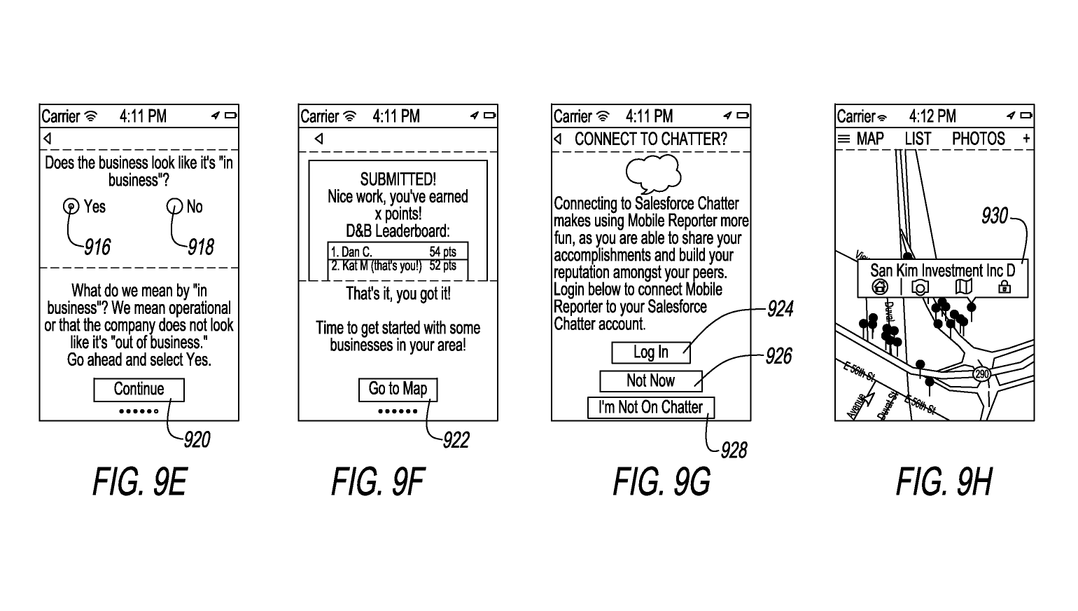

In FIG. 8A, if the user earns a sufficient number of points at 800, the map is unlocked, and at 802, a second tutorial is started, as shown in FIG. 9A. The user activates the Continue button at 900 to change the display to that of FIG. 9B. The user is then instructed to click on a pin 902 to select a business in the vicinity of the mobile device being used, as represented by circle 304. In FIG. 9C, a toolbar 904 provides choices on how to submit information. The user is instructed to click on the map icon 906 (as distinguished from the camera icon 908 or the lock icon 910). In FIG. 9D the information that is currently in the database is displayed, asking the user to confirm whether Joe's Chicken Shack is at 103 JFK Parkway. If Joe's Chicken Shack is not at the location, the user selects NO 914, and a different screen appears to allow for the entry of data concerning what business is at the location. If the answer is that Joe's Chicken Shack is present at the location, the user answers YES 912. The display of FIG. 9E is presented. The user is asked to indicate whether the business appears to be “in business” or actually operating as a business, and does not appear to be “out of business.” When the user answers that question, as either YES 916 or NO 918, and selects Continue at 920, the tutorial is completed and the display of FIG. 9F is shown. Then, at 804 of FIG. 8A, the map is unlocked. By selecting button 922, the user can go to the map. However, first, at 806, and as represented in FIG. 9G, if the user has not previously signed up for chatter communication, the user is given the option of signing up for chatter communication, which can be an internal sales force bulletin board. Chatter communication is advantageous in that it allows the user to share accomplishments and build reputation among peers, and adds an element of fun to the data accumulation process.

If the user has not previously signed up for chatter communication, on the screen of FIG. 9H, the user can log in by selecting button 924. The user can defer signing up for chatter communication by selecting button 926. If the user is not on chatter, and wishes to continue to the next screen, the user can select button 928. At 808 of FIG. 8A, the user can return to the main map, as represented in FIG. 9H, where an action icon toolbar 930 is displayed.

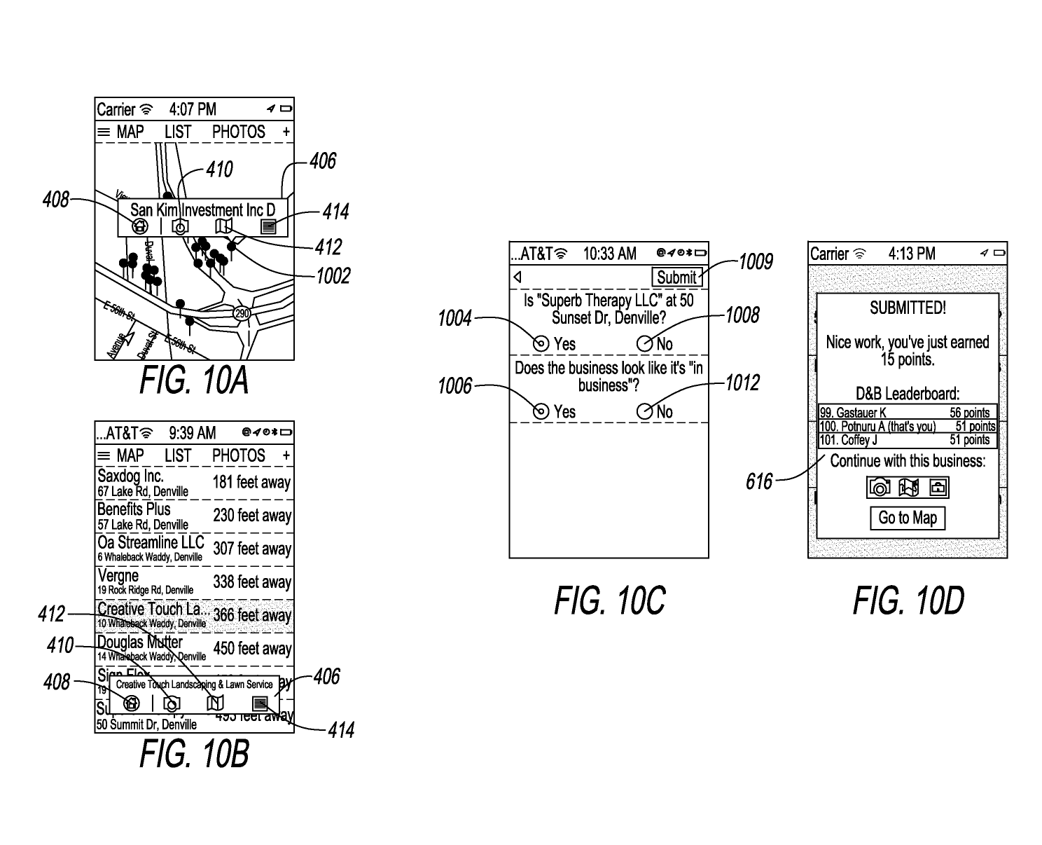

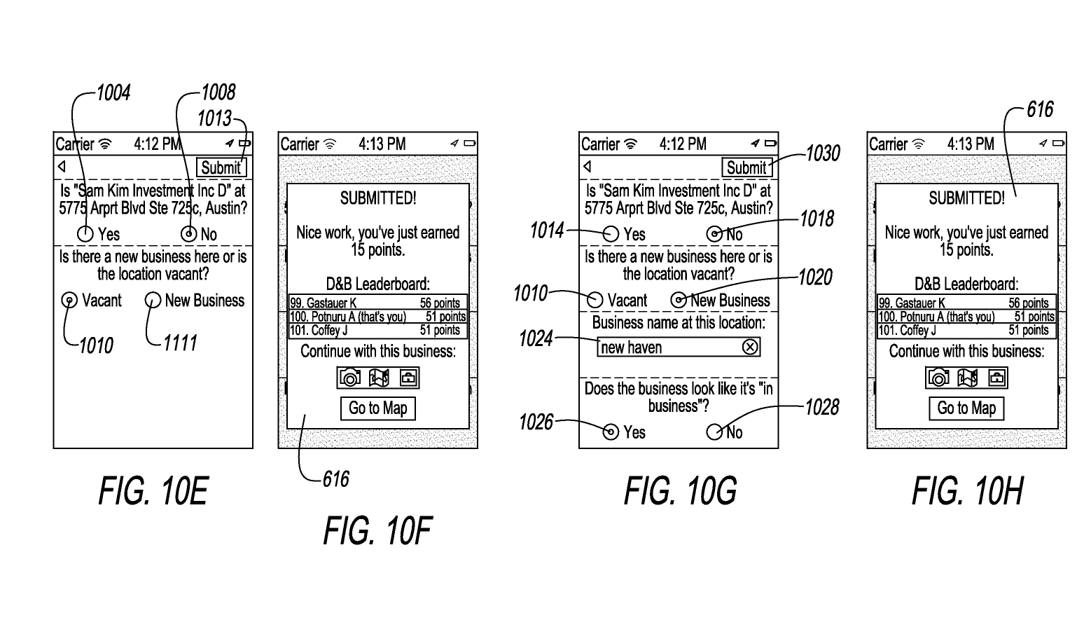

FIG. 8B illustrates the use of the map icon, starting at 810. The map icon may be selected by clicking on a pin 1002 in FIG. 10A or one of the listed businesses in the list of FIG. 10B, to bring up the toolbar 406. In either case, if the map icon 412 is selected, at 812, the user is presented with a screen, as in FIG. 10C, that presents an inquiry as to whether a specified business is at the address represented by the selected pin 1002. If the user answers that the business is present with button 1004 and looks as if it is “doing business” with button 1006 (814 of FIG. 8B), a submission is made at 816, using the submit button 1009, and the submitted screen 616 is displayed, as shown in FIG. 10D. In FIG. 10E, if the business is not present, this is indicated by activating button 1008. The question arises (820 of FIG. 8B) as to whether the space where the business should have been is vacant. If the space is vacant, this is indicated by selecting button 1010 of FIG. 10E (corresponding to 822 of FIG. 8B). If instead a new business is present, button 1111 is selected. A submission is made by selecting submit button 1013. The submitted screen 616 of FIG. 1 OF is then displayed (corresponding to 824 of FIG. 8B).

In FIG. 10G, if the expected business is not present, the user selects button 1018. If a new or different business is at the address, the user selects button 1020 (corresponding to 826 of FIG. 8B). At 1024, a field for entering the name of the new business is provided. Corresponding to 828 of FIG. 8B, at 1026, the user can indicate that the new business appears to be “in business” or at 1028 the user can indicate that the new business does not appear to be “in business.” At 830, the user has the option to submit the selections made by activating button 1030. When submitted, the submitted screen 616 of FIG. 10H is displayed, corresponding to 832 of FIG. 8B.

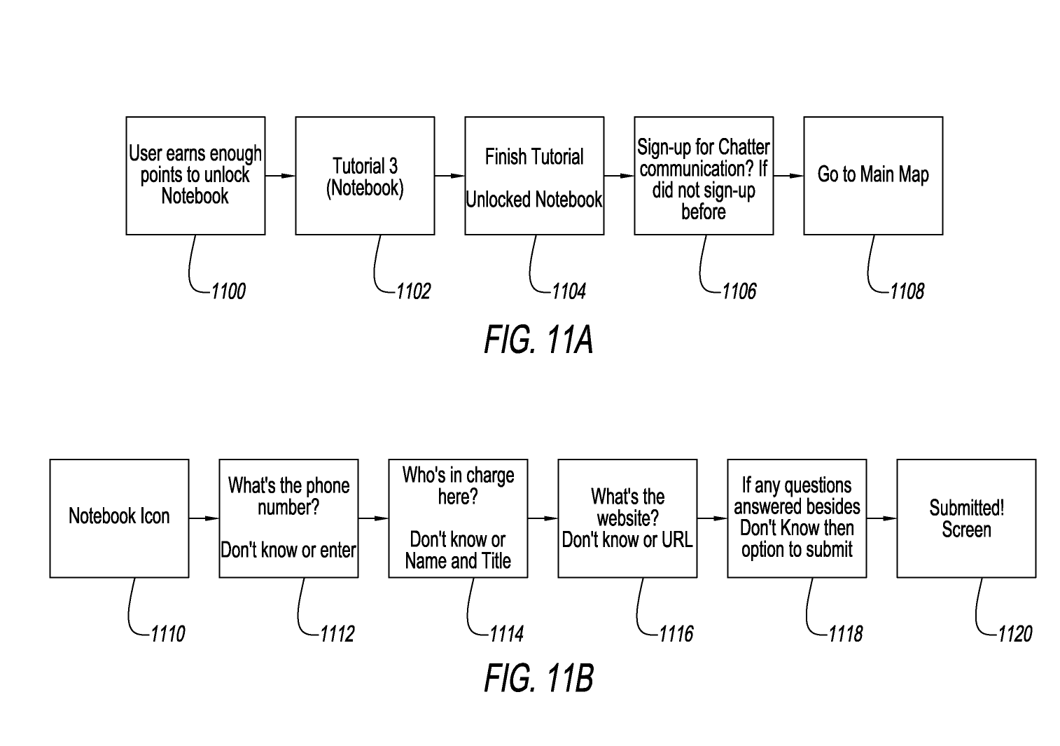

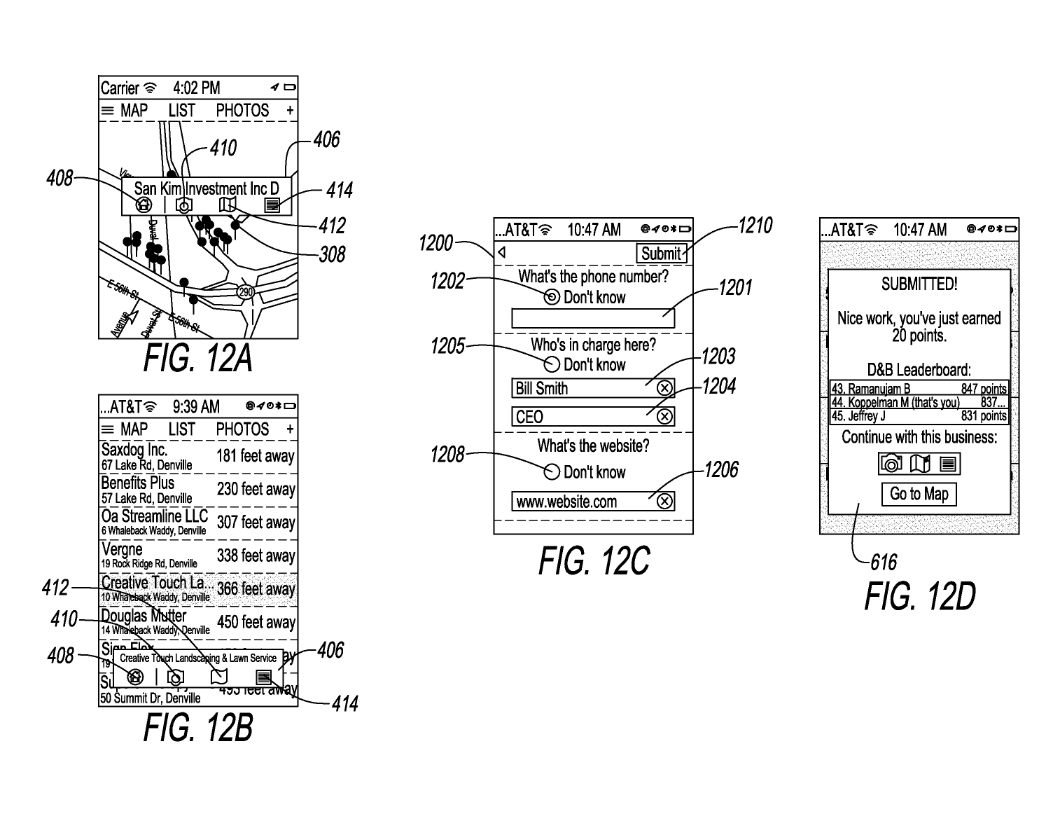

Referring to FIG. 11A, at 1100 the user has earned enough points to unlock the notebook. At 1102 the user participates in a third tutorial on the use of the notebook. This tutorial is not described in detail herein, but in general instructs the user to follow the steps described below with respect to FIGS. 11B, 12A, 12B, 12C and 12D. At 1104, when the tutorial has been completed, the notebook is unlocked. At 1106, the user can sign up for chatter communication if the user has not previously done so. At 1108, the user returns to the main map.

Referring to FIG. 12A, a pin 308 representative of a location is selected by the user. The action icon toolbar 406 appears and the user selects notebook icon 414 (1110 in FIG. 11B). Alternatively, the user selects a business from the list in FIG. 12B, The action icon toolbar 406 appears and the user selects notebook icon 414. In either case, a data input screen 1200 of FIG. 12C is displayed. At 1112 of FIG. 11B, the user has the opportunity to enter a telephone number for the business in field 1201 of the display of FIG. 12C, or to indicate that the user does not know the telephone number by activation of button 1202. At 1114, the user is presented with a field for entering the name of the person in charge of the business (field 1203 of FIG. 12C), the title of that person in field 1204, or to indicate that the user does not know by activating button 1205. At 1106, the user is asked to enter the URL of the website in a field 1206 of FIG. 12C, or to activate a button 1208 indicating that the user does not know the URL of the website of the business.

At 1118, if any question presented (telephone number, who is in charge, URL) is answered with other than “Don't know”, the user has the option to activate the submit button 1210, and the submitted screen of FIG. 12D appears (1120 of FIG. 11B).

Referring to FIG. 13, at 1300, side navigation may be accessed from any map display by activating icon 400 (of FIG. 4A). Four choices are presented to the user, preferably by way of a screen for each choice. At 1302, the user can select the About screen which, at 1304, provides a menu of choices including, but not necessarily limited to, links for privacy policy, terms and conditions, and descriptive text concerning the operation of the application described herein.

At 1306, a status screen may be selected. At 308, a screen is displayed showing the user's present level in the game, points required to reach the next level, a list of unlocked equipment, the user's position on the leader board, and an icon for badges. If the user selects the badge icon at 1310, all collected badges are displayed at 1312. At 1314, the user can click on a badge. At 1316, the badge name, its icon and a description of what is needed to earn that badge is displayed.

At 1318, the user is given the option of exiting side navigation and returning to the map display screen.

At 1320, the user is given the option of tuning chatter on or off. At 1322, if the chatter is turned off, submission to sales force chatter is disabled.

A platform system receives the data from the mobile device, obtained as described above. The data then becomes part of a business information database, and is used, in conjunction with other business data, to assist in reporting on the business, including the name, location, financial condition, type of business activity, and other data concerning the business.

Thus, the apparatus and method described herein allow viewing of a list of business near a particular location, verifying that a business exists at that location and that business is being conducted, adding new business data concerning new businesses (including photographs thereof). The use of GPS data from a GPS receiver in the device being used to acquire the data assures that the person acquiring the data was actually at the reported location. Employees of a company, or in some cases those who are not employees, are incentivized to participate by the game-like nature of a reward system in which points are awarded each time data is submitted. A platform that receives the information may have a set of rules, or a rules engine, to process the data to produce valuable information about the business for which information is obtained using the system and method disclosed herein.

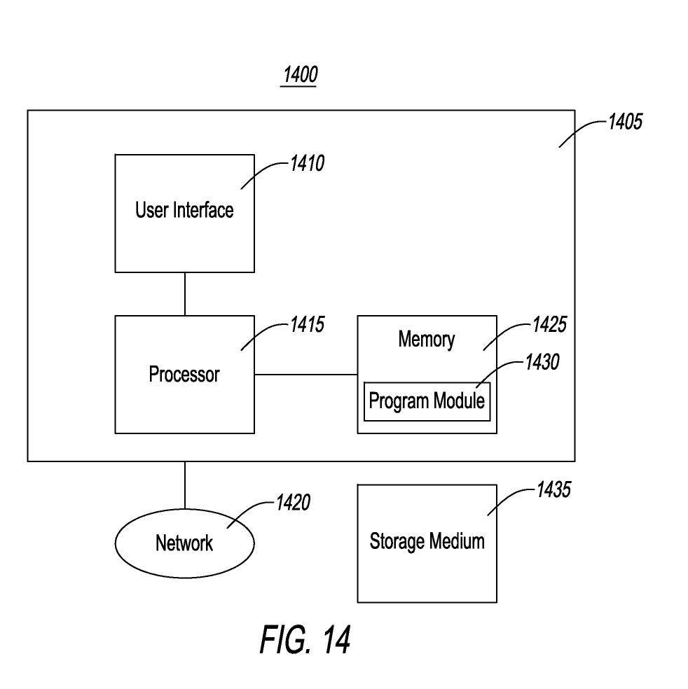

Referring to FIG. 14, there is shown a system, generally represented by reference numeral 1400, of the present disclosure, generally contained within the device (a smart phone or a tablet, or other portable device such as a PDA) used to acquire the data. System 1400 includes a computer 1405 coupled to a network 1430, e.g. the Internet.

Computer 1405 includes a user interface 1410, a processor 1415, and a memory 1420. Computer 1405 may be implemented on a general-purpose microcomputer. Although computer 1405 is represented herein as a standalone device, it is not limited to such, but instead can be coupled to other devices (not shown) via network 1430. Unless other provisions are made for transferring the data on business that is acquired, such connection, by way of a network, is required. The network may be the Internet, a telephone network, a virtual private network, or any other suitable data transfer network.

Processor 1415 is configured with logic circuitry that responds to and executes instructions.

Memory 1420 stores data and instructions for controlling the operation of processor 1415. Memory 1420 may be implemented in a random access memory (RAM), a hard drive, a read only memory (ROM), or a combination thereof. One component of memory 1420 is a program module 1425.

Program module 1425 contains instructions for controlling processor 1415 to execute the methods described herein. For example, as a result of execution of program module 1425, processor 1415 can provide all of the functionality needed to implement the system and method described herein for obtaining data concerning a business at particular locations.

The term “module” is used herein to denote a functional operation that may be embodied either as a stand-alone component or as an integrated configuration of a plurality of sub-ordinate components. Thus, program module 1425 may be implemented as a single module or as a plurality of modules that operate in cooperation with one another. Moreover, although program module 1425 is described herein as installed in memory 1420, and therefore being implemented in software, it could be implemented in anyone of hardware (e.g., electronic circuitry), firmware, software, or any combination thereof.

User interface 1410 includes an input device, such as a keyboard or speech recognition subsystem, for enabling a user to communicate information and command selections to processor 1415. Specifically, data to be used to implement the methods described herein can be entered with user interface 1410, or can be downloaded from network 1430. User interface 1410 also includes an output device including, but not limited to, a display or a printer. A cursor control including, but not limited to, a mouse, track-ball, or joy stick, allows the user to manipulate a cursor on the display for communicating additional information and command selections to processor 1415.

Processor 1415 outputs to user interface 1410, a result of an execution of the methods described herein. Alternatively, processor 1415 could direct the output to a remote device (not shown) via network 1430.

While program module 1425 is shown as already loaded into memory 1420, program module 1425 may be configured on a storage medium 1435 for subsequent loading into memory 1420. Storage medium 1435 can be any conventional storage medium that stores program module 1425 thereon in tangible form. Examples of storage medium 1435 include, but are not limited to, a floppy disk, a compact disk, a magnetic tape, a read only memory, an optical storage media, universal serial bus (USB) flash drive, a digital versatile disc, and a zip drive. Alternatively, storage medium 1435 can be a random access memory or other type of electronic storage, located on a remote storage system and coupled to computer 1405 via network 1430.

It will be understood that the disclosure may be embodied in a computer readable non-transitory storage medium storing instructions of a computer program which when executed by a computer system results in performance of steps of the method described herein. Such storage media may include any of those mentioned in the description above.

The techniques described herein are exemplary, and should not be construed as implying any particular limitation on the present disclosure. It should be understood that various alternatives, combinations and modifications could be devised by those skilled in the art. For example, steps associated with the processes described herein can be performed in any order, unless otherwise specified or dictated by the steps themselves. The present disclosure is intended to embrace all such alternatives, modifications and variances that fall within the scope of the appended claims.

The terms “comprises” or “comprising” are to be interpreted as specifying the presence of the stated features, integers, steps or components, but not precluding the presence of one or more other features, integers, steps or components or groups thereof.

What is claimed is:

1. A method for reporting data concerning a business, comprising:
providing, on a device, a map of the geographic location of the business, wherein the business is represented by a marker on the map;
selecting the marker to display the name of the business;
receiving an instruction to open a toolbar to provide options for inputting information concerning the business;
providing information concerning the business to the device via at least one of the options; and
transmitting the information to a central database by using the device.

2. The method of claim 1, wherein the toolbar includes icons for inputting data as to whether the business is being run out of a residence, a camera for providing an image of the location of the business, a map of the location of the business, and a notebook for entering information concerning the business.

3. The method of claim 2, wherein selecting an icon on the toolbar causes the device to display screens for inputting the information concerning the business.

4. The method of claim 3, wherein selecting the icon for inputting data as to whether the business is being run out of a residence causes the device to display a screen with a yes button, a no button and a submit button.

5. The method of claim 2, wherein selecting the icon of a camera causes the device to display an image generated by a camera associated with the device, and a button for selecting the image for reporting.

6. The method of claim 5, wherein the image is acquired by using the camera to capture an image of the business.

7. The method of claim 3, wherein selecting the map icon causes the device to display a screen for entering information for each of whether the business is at a location, whether it appears that business is being conducted at that location, whether the location is vacant, whether a different business is present at the location, and whether the different business appears to be doing business at the location.

8. The method of claim 3, wherein selecting the notebook icon causes the device to display screens for entering information for each of the telephone number of the business, who is in charge of the business, the title of who is in charge of the business, and a uniform resource locator of a website of the business.

9. The method of claim 1, further comprising determining a current position of the device.

10. The method of claim 9, wherein the current position of the device is determined by one of a GPS receiver associated with the device and entering a location of the device.

11. The method of claim 1, wherein the reporting of data concerning a business earns points of a game for users of the device as data is reported.

12. The method of claim 1, further comprising a user of the device chattering with other users of other devices who are acquiring information concerning businesses.

13. A system for reporting data concerning a business, comprising:
a device providing a map of the geographic location of the business, wherein the business is represented by a marker on the map;
an input apparatus for:
allowing a user of the device to select the marker to display the name of the business;
receiving an instruction to open a toolbar to provide options for inputting information concerning the business; and
receiving information concerning the business via at least one of the options; and
a connection for transmitting the information to a central database.

14. The system of claim 13, wherein the toolbar includes icons for inputting data as to whether the business is being run out of a residence, a camera for providing an image of the location of the business, a map of the location of the business, and a notebook for entering information concerning the business.

15. The system of claim 15, wherein selecting an icon on the toolbar causes the device to display screens for inputting the information concerning the business.

16. The system of claim 15, wherein selecting the icon for inputting data as to whether the business is being run out of a residence causes the device to display a screen with a yes button, a no button and a submit button.

17. The system of claim 14, wherein selecting the icon of a camera causes the device to display an image generated by a camera of the device, and a button for selecting the image for reporting.

18. The system of claim 17, wherein the image is acquired by using the camera to capture an image of the business.

19. The system of claim 15, wherein selecting the map icon causes the device to display a screen for entering information for each of whether the business is at a location, whether it appears that business is being conducted at that location, whether the location is vacant, whether a different business is present at the location, and whether the different business appears to be doing business at the location.

20. The system of claim 15, wherein selecting the notebook icon causes the device to display screens for entering information for each of the telephone number of the business, who is in charge of the business, the title of who is in charge of the business, and a uniform resource locator of a website of the business.

21. The system of claim 13, further comprising apparatus for determining a current position of the device.

22. The system of claim 21, wherein the apparatus for determining the current position of the device is one of a GPS receiver associated with the device and a screen for entering a location of the device.

23. The system of claim 13, wherein the reporting of data concerning a business earns points of a game for users of the device as data is reported.

24. The system of claim 13, configured to allow a user of the device to chatter with other users of other devices who are acquiring information concerning businesses.

25. A computer readable non-transitory storage medium storing instructions of a computer program which when executed by a computer system results in performance of steps of a method for reporting data concerning a business, comprising:
providing, on a device having the computer system, wherein the computer system has a processor, a memory and a display, a map of the geographic location of the business on the display, wherein the business is represented by a marker on the map;
displaying the name of the business if the marker is selected;
receiving an instruction to open a toolbar to provide options for inputting information concerning the business;
providing information concerning the business to the device via at least one of the options; and
transmitting the information to a central database by using the device.
